(19) United States
(12) Patent Application Publication
(10) Pub. No.: US 2008/0166938 A1
(43) Pub. Date: Jul. 10, 2008

(54) MICROFIBER SPLIT FILM FILTER FELT AND METHOD OF MAKING SAME

(75) Inventors: Marcello Cattaneo ADORNO, London (GB); Jose Antonio de Almeida NETO, Duque de Caxias (BR)

Correspondence Address: LOCKE LORD BISSELL & LIDDELL LLP;ATTN: IP DOCKETING, 600 TRAVIS, SUITE 3400, HOUSTON, TX, 77002-3095, US

(73) Assignee: TEADIT INDUSTRIA E COMERCIO LTDA., Rio de Janeiro (BR)

(21) Appl. No.: 11/969,904

(22) Filed: Jan. 6, 2008

Related U.S. Application Data
(60) Provisional application No. 60/884,078, filed on Jan. 9, 2007.

(51) Int. Cl. B32B 5/26; D04H 13/00; D04H 5/02; D02G 1/20

(52) U.S. Cl. 442/35; 442/327; 442/402; 442/408; 264/103

(57) ABSTRACT

A nonwoven felt formed from fluoropolymer film, which is split and fibrillated to form a network structure, and then entangled.

### CROSS REFERENCE TO RELATED APPLICATIONS

This application claims the benefit of U.S. Provisional Application Ser. No. 60/884,078, filed Jan. 9, 2007, which is incorporated by reference.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to felts; and more specifically related to a felt used as filter media for a high temperature gases.

2. Description of the Related Art

The technology for the production of synthetic fiber felts is well known in the art. Felts (i.e. nonwoven unbounded fibrous structures deriving coherence and strength from interfiber entanglement and accompanying frictional forces) represent an old form of textile fabric. Felt materials have been used commonly in industrial applications. They have good dimensional stability and can be made with a wide variety of natural or synthetic fibers to withstand the mechanical, chemical and thermal requirements demanded by the application.

During the last two decades, a number of technologies have been developed to make fibers and yarns from polytetrafluoroethylene (PTFE), often referred to by Dupont's trademark TEFLON™. PTFE has a wide range of useful properties because it is a perfluoropolymer, with all hydrogen being substituted by fluorine, leading to a highly inert material.

There are a number of patents describing the use of PTFE fibers and yarns for high temperature, chemical and weather resistant items such as filter media, bearing cloths, radar coverings, etc.

As an industrial material, such as filtration material, for example, PTFE has exhibited excellent utility in harsh chemical environments, which normally degrade many conventional metals and polymeric materials. A significant development in the area of particle filtration was achieved when expanded PTFE (ePTFE) membrane filtration media were incorporated as surface laminates on conventional filter elements. Felts constructed with PTFE fibers hold superior chemical and thermal resistance and desirable mechanical properties, especially low coefficient of friction. Selection of the type of material used is typically based on the fluid stream with which the filter element comes in contact, the operating conditions of the systems and the type of particulate being filtered.

For many filtration applications the preferred filtration media comprises a composite of felt (e.g., PTFE, expanded PTFE, polypropylene, fiberglass, etc) laminated to a microporous membrane (e.g. expanded PTFE film). Suitable material of this type is commercially available from W.L. Gore and Associates, under the trademark GORE-TEX™ membrane tubular filter sleeves.

U.S. Pat. Nos. 2,893,105 and 2,910,763 assigned to Lauterbach are related to the formation of fibers into nonwoven felt-like products. These felt products are made from PTFE and others synthetic or natural staple fibers by a needle punch method.

The Lauterbach patent discloses the formation of synthetic filamentary material into nonwoven felt-like products. This is accomplished by forming filamentary material, at least the preponderant part of the material being retractable and of synthetic composition, into a loose batt as a plurality of superimposed substantially horizontal parallel layers, the filamentary material lying essentially coplanar on each layer, forcibly orienting some of the filamentary material from each layer into substantial parallelism with one another and into at least one adjacent layer at occasional intervals distributed throughout the batt, and then compacting the batt by exposure to treatment effective to retract the retractable component without fusing the fibers.

U.S. Pat. No. 2,933,154 is related to a process for filtering suspended particles from gaseous media. The felt material is obtained by a needle punch process using staple fiber. Monofilaments and combination of monofilaments and staple fiber can also be used.

U.S. Pat. Nos. 4,361,619 and 4,840,838 disclose a filter of PTFE and glass staple fibers blends suitable for the preparation of felts for gas filtration. This composite felt is comprised of a needled nonwoven batt by making a carded web, which was crosslapped to form a batt, and then needled to form a felt. This crosslapped batt could also be needled to a supporting scrim of woven PTFE to form a felt or felted scrim. U.S. Pat. Nos. 6,468,930 and 6,151,763 also describes felts made from staple fibers of fiberglass and PTFE.

U.S. Pat. No. 4,983,434 Sassa discloses that an expanded porous PTFE membrane is employed in laminar conjunction with a PTFE felt, in which the felt is reinforced with a woven scrim. The resulting laminate is useful in filter bag assemblies (a filter used in the filtration of solids from fluid streams). The porous membrane used is prepared by a number of different known processes, but is preferably prepared by expanding PTFE as described in U.S. Pat. Nos. 4,187,390, 4,110,392, and 3,953,566, to obtain expanded, porous PTFE. The felt is prepared by needle punching of PTFE staple fibers as generally described in Lauterbach U.S. Pat. No. 2,893,105, and the felt used herein will sometimes be referred as needle punched felt. The woven scrim element can be made of any PTFE, but preferably is expanded porous PTFE. The needle punch procedure results in simultaneous conversion of the loose webs into needle punch felt, and intimate contact of the scrim and staple fibers sufficient to form a unitary coherent material. A polymer adhesive, such as a fluorinated ethylene propylene (FEP) copolymer, is coated onto the felt and the layer of ePTFE membrane material is laminated to the FEP containing side.

U.S. Pat. No. 5,620,669, Sassa et al discloses a catalytic filter material for use in removing contaminants such as NOx from a fluid stream. This filter employs composite fibers of expanded PTFE filled with catalytic particles. The composite tape is processed over a rotating pinwheel to form a tow yarn. Once the yarn passes through the pinwheel a “spider web” of fine fibers is formed that are connected together at random points along the tow. Once the tow is formed, the tow yarn is then chopped into short staple fibers. The composite fibers are chopped into staple fibers that are needle punched into a scrim backing material to form a felt. The felt material is then laminated on at least one side with a protective microporous membrane.

U.S. Pat. No. 6,133,165 describes a method of producing split yarns having a network structure by splitting an uniaxially stretched PTFE film in the stretched direction with needle blade rolls, a method of producing PTFE filaments having branches by cutting the network structure of the split yarns in the longitudinal direction, and further a method of producing cotton-like PTFE materials by cutting the PTFE split yarns or PTFE filaments to given length and then opening. The major feature of this process is to once split a uniaxially stretched article of a PTFE film without tearing directly into staple fibers. In order to obtain such a network structure, the relation of feed speed of the uniaxially stretched PTFE film and the rotation speed of the needle blade rolls, and the arrangement and the number of needles of the needles blade rolls must be properly selected.

U.S. Pat. No. 6,156,681 Daikin relates to a process for producing a multilayered felt by placing a web of PTFE staple fibers on at least one surface of a felt and then joining the PTFE staple fibers and the fibers that form the felt by intermingling through water jet needling and or needle punching. It is preferable that the PTFE staple fibers are obtained by tearing and opening a uniaxially stretched PTFE film with a needle blade roll rotating at high speed and that immediately after the opening, the PTFE staple fibers are accumulated on the felt to be joined to form a web.

There are advantages to using a nonwoven felt formed by microfibers for filtration applications; however, in the carding process, where staple fibers are opened, cleaned and oriented into a web which is crosslapped and formed in to a batt, it is extremely difficult to convert fine fibers and microfibers to a web, because the amount of neps (small knot of tangled fiber) and fiber breakage. The purpose of the present invention relies on obtaining a felt comprising a web of fluoropolymer material from uniaxially drawn film, split to form a network structure with connected fine fibers and microfibers. The batt (crosslapped material) is not made of separate (staple) fibers, but from a stretched film which is processed by splitting in the stretched direction with a needle blade roll, so that when spread in the cross direction, the film becomes net-like. Another object of the present invention is to produce a felt with small pore size, high surface area, and good distribution. Another object of the present invention is to improve burst strength. Yet, another object of the present invention is to provide a filter felt for dust collection, which has high filter efficiency and low cost of production.

The inventions disclosed and taught herein are directed to an improved nonwoven felt formed from fluoropolymer film, which is split and fibrillated to form a network structure, and then entangled.

### BRIEF SUMMARY OF THE INVENTION

Applicants have created a nonwoven material comprising a web of fluoropolymer film material from uniaxially stretched fibrillated film split in a lengthwise direction to form a network structure wherein the material is formed into a batt without cutting, and then entangled.

The present invention is a felt-like material comprising a web of fluoropolymer material from uniaxially drawn film, split to form a network structure, which is entangled by needle punching or by hydroentanglement. This new product uses a split film where fine fiber and microfibers are connected to each other instead of discontinuous short staple fibers. The felt can be reinforced with a woven, knit, or multiaxial scrim or with filaments in the cross direction or in the lengthwise direction or a combination thereof Also, a membrane can be laminated to the felt by an adhesive or other method.

The ratio of the volume of air or void contained in the fabric to the total fabric volume is defined as porosity. The pores are formed by the small space that occurs between the individual fibers. The amount, size, and distribution of porosity influence the efficiency of filtration. As the porosity of the filter increases, the pressure drop decreases. But when the pores are bigger, particles of larger size pass through, decreasing the filter efficiency. A nonwoven felt containing microfibers is required if the main objective is to separate finer particles; the felt should have pores of small size and good distribution.

It is well known for particles that are smaller than the pore size there are five separate mechanisms that can occur. (1) Interception—When a particle tries to pass the fiber surface at a space with a distance that is smaller than the particle's radius, it merely collides with the fiber and may be stopped or arrested. (2) Inertial deposition—The velocity of a flow increases when passing through the spaces of a filter because of the continuity equation. When a heavy particle is carried by the flow, it is thrown out of the flow stream lines due to its inertia (mass X speed). This may cause the particle to be caught by other fibers. (3) Random diffusion (Brownian motion)—Due to Brownian-type motion, which can be described as random vibration and movement of particles in a flow, particles follow a zigzag route which increases the chance of being caught by the fiber material instead of trying to pass straight through the openings of the filter. (4) Gravitational forces—Under the influence of gravity, a particle that is sinking may collide with the fiber and get caught. (5) Electrostatic deposition—Submicron particles are difficult to capture even with a combination of mechanical methods. It is well known that strong electrostatic forces of fibers attract the particles. Therefore, fibers may be given permanent electrical charges to attract small or medium sized particles. Charged fibers increase the filtration efficiency.

An improvement of the present invention is the presence of microfibers (fibers of less than 1 denier), which are required to achieve finer filtration. During the splitting of the film with a needle blade roll, many of microfibers are formed and remain fixed to the network structure. These microfibers increase the total available fiber surface area and electrostatic charge and reduce the porosity of the felt, which results in improved dust collection efficiency. In the conventional carding process, it is extremely difficult to convert fine fibers and microfibers to a web, because the lack of openness of the fibers deteriorates the web quality with an increase of neps count and fiber breakage. The carding machine is designed to process fibers mechanically through a series of rollers covered with wires, and the objective is to open and comb the fibers and form a web. The carding process removes dust (especially when processing natural fibers), short fibers, and neps, but only part of the neps are actually eliminated and most are opened out. Unfortunately the properties of microfibers that make them attractive for the filtration application are also the same that lead to difficulties in processing. Fine diameter causes an increase in fiber flexibility and there are more chances of neps formation and fiber breakage in the carding process. Microfibers in the present invention are part of the split film that is crosslapped or aligned in the machine direction and the entanglement can be provided by either needle punching or by hydroentanglement. The batt of this invention is not formed by a card or other conventional system but by a split film with connected fine fibers and microfibers. The split film can be stretched along the transversal direction before forming the batt; then several layers of split film are formed in to a batt, either by crosslapping a single split film, or by combining several films in parallel or by a combination of the above.

Another improvement of the present invention is a significant increase in burst strength, which may be obtained by the parallel filaments that were not broken during the needlepunch process. These continuous filaments can act as reinforcement and consequently may improve the strength and stability of the material when compared with the previous felt. The application of a pressure force perpendicular to the plane of the felt can generate biaxial tensile forces perpendicular to the plane of the felt. The modulus of elasticity and the tensions that develop as a result of the pressure can influence the overall extension and shape of the felt under pressure. When air passes through the felt, the pressure can stretch it. If the felt is not strong enough, open areas may occur and the cover factor may be reduced, which can increase it porosity and permeability. Furthermore, PTFE fibers are viscoelastic and may creep under the load. The air permeability of the felt may increase with time because of the continuous application of force. Therefore, it is important that the felt modulus be high enough so that the felt will not get out of shape, distort, open or open up to the point that it lets through an excessive amount of gas and cease to be an effective filter.

Another advantage of the present invention is it may be produced using a lighter scrim, thus reducing the overall weight of the felt and increasing the efficiency of filtration. Other improvements of the present invention are a reduction in cost and the simplified production process when compared with other conventional processes.

### BRIEF DESCRIPTION OF THE SEVERAL VIEWS OF THE DRAWINGS

FIG. 1 is a schematic representation of a split film before and after splitting.

FIG. 2 is a schematic representation of a split film stretched in the transversal direction with connected fine fibers and microfibers.

FIG. 3 is a diagrammatic view of the fibrillating system, which splits the film.

FIG. 4 is a diagrammatic view of the curved bars, which stretch the split film in the transversal direction.

FIG. 5 is a diagrammatic view of the crosslapper, which delivers the split film to a conveyor belt in the transversal direction of the present invention.

FIG. 6 is a diagrammatic view of the mechanism, which delivers the split film directly in the length-wise direction on the conveyor belt of the present invention.

FIG. 7 is a diagrammatic view of the mechanism, which delivers the combination of several split films directly in the length-wise direction on the conveyor belt of the present invention.

### DETAILED DESCRIPTION

The Figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

The invention is a nonwoven, felt-like material, comprising a web of fluoropolymer material from uniaxially drawn film, split to form a network structure, which is entangled by needle punching or by hydroentanglement. An expanded PTFE tape is formed in the following manner: a fine powder PTFE resin is mixed with a liquid lubricant, in a proportion ranging from 17% to 29% of lubricant and 83% to 71% of PTFE, respectively until a compound is formed. In this mixture other ingredients can also be added, such as fillers, pigments or other organic or inorganic components. In a subsequent step, the compound is pressed in a pre-form machine forming a billet. This billet is then taken to an extruding machine, where the material is forced to a die, forming a coherent extrudate. This process may be responsible for arranging the PTFE particles into fibrils. A reduction ratio of about 10:1 to 1000:1 maybe used, and for most application a reduction ratio of 25:1 to 200:1 is preferred. The extrudate is then pressed through calender rolls in order to form a tape with a thickness ranging between 55 and 1500 μm. The tape resulting from the calendering is then passed through a drying oven to remove the liquid lubricant. The tape is stretched in at least one direction about 1.1 to 200 times its original length, with about 2 to 160 times being preferred. The stretching is carried out by passing the dry tape through tensioning rollers between the two units of pulling rollers at a temperature of between 100 to 450° C. The stretching can take place in one, two or more steps under heating, by means of heating element that may be an oven, a hot-air, steam or high-boiling-point liquid heated plate or a heated cylinder. The thickness of the uniaxially stretched film is from 1 to 100 μm, preferable from 5 to 40 μm. After stretching, the thin film may be wound in a winder machine.

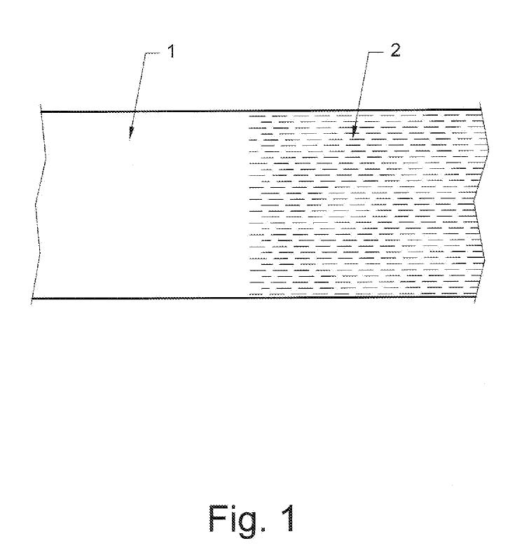

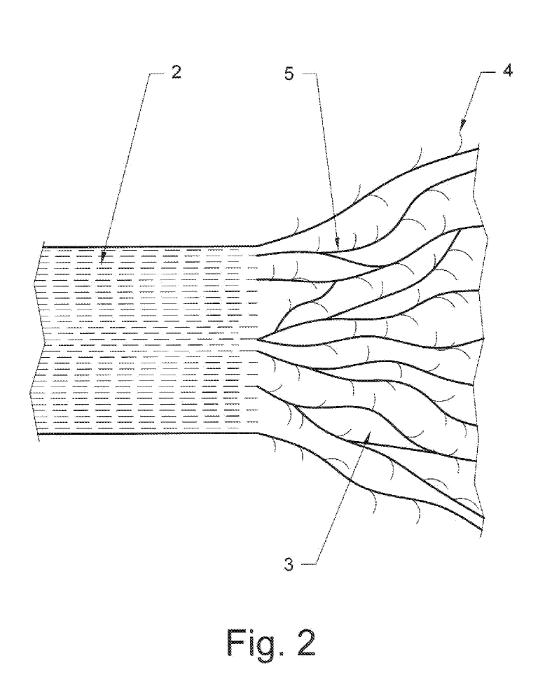

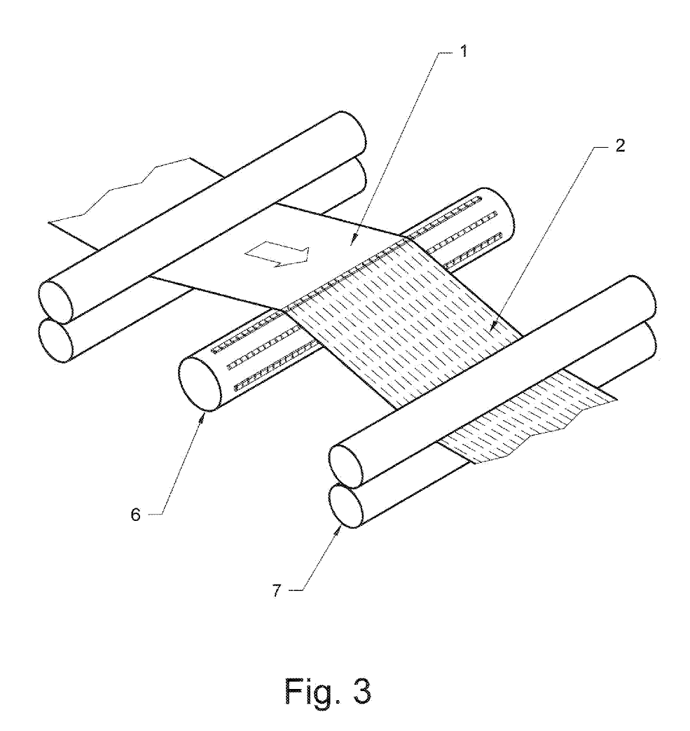

The PTFE film 1 is mechanically split along its length by one or more needle blade rolls so that a network of fibers 3 is formed, such fibers being connected to each other at random points, as can be seen in FIGS. 1 and 2. As shown in FIG. 2, the split film 2 has fibers 5 with many suspended microfibers 4. The fibrillating system consists of one or more needle blade rolls positioned between two pairs of cylinders that nip the film. A typical setup for a one roll fibrillating system is shown in FIG. 3. The nip cylinders 7 speed is between 1 and 200 m/min, and the needle blade roll 6 speed is between 2 and 10000 m/min.

Next, while in the previous art the fibrillated PTFE film is cut to given length so as to form short staple fibers which are subsequently carded and formed in to a batt by crosslapping or other methods, in the present invention the split film is used to form a batt without cutting it in to discontinuous fibers.

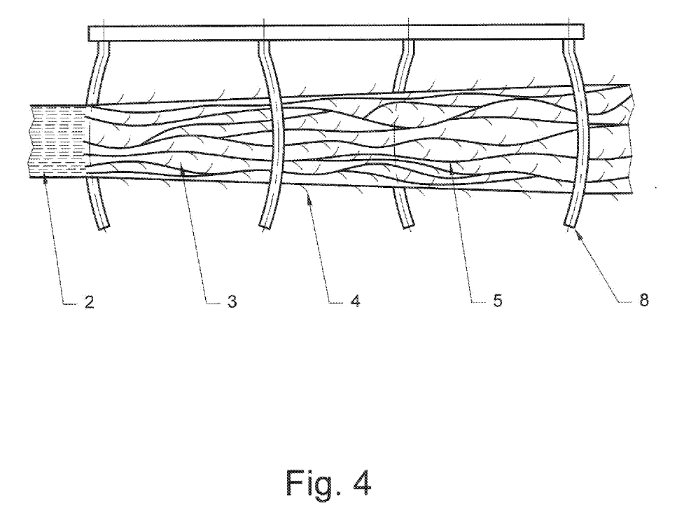

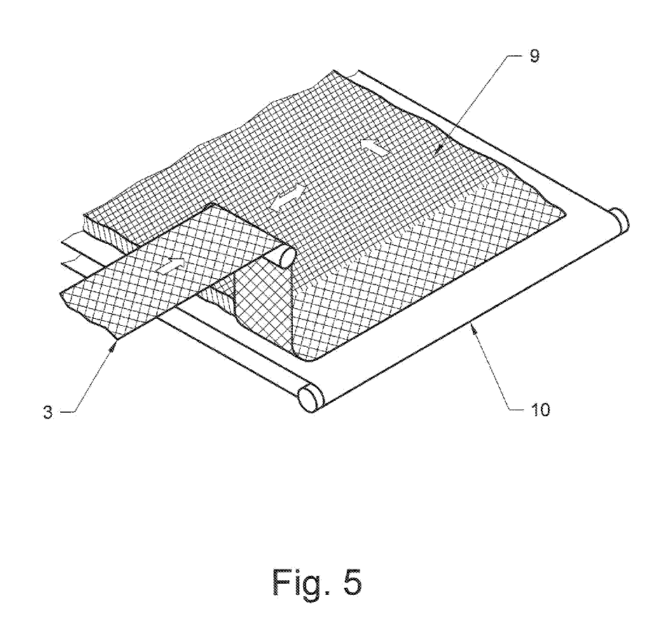

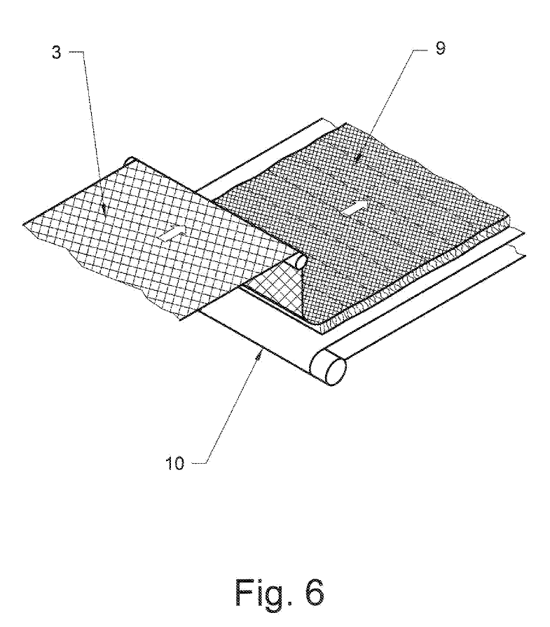

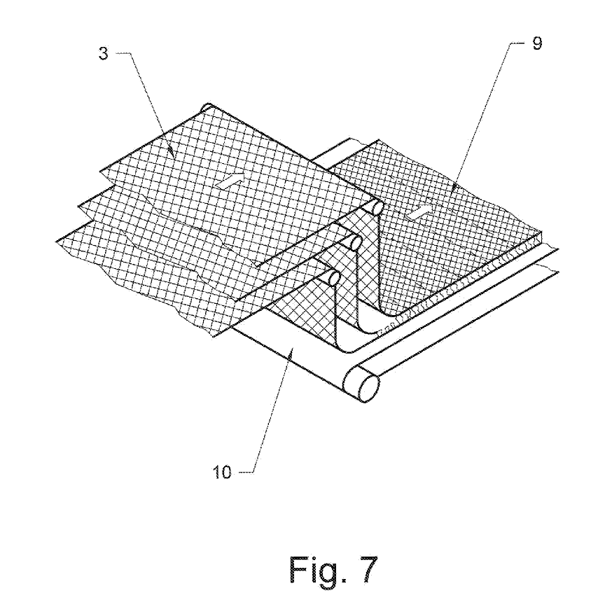

The film is stretched in the cross direction by a ratio of 1.1 up to 10 times its original width, so that its appearance is similar to a fishing net or a spider web (FIG. 4); this step can be performed by using curve bars 8 that gradually open the web in the transversal direction decreasing the weight per area and consequently increasing the number of layers necessary to reach final batt weight; the formation of a multilayer film also improves the evenness of the nonwoven material. Instead of curve bars, cylinders with screw or any other suitable method that gradually opens the web can also be used. Several layers of the net-like film are then combined to form a batt. This can be achieved by crosslapping one or more films over a conveyor belt, so that they lie in a transversal direction as shown in FIG. 5, or by one split film (FIG. 6) or also by combining several films 9 directly in the length-wise direction on the conveyor belt 10 such as shown in FIG. 7. The number of layers to be combined will be such as to achieve the desired thickness and weight in the final nonwoven material.

The batt is then needle punched into a scrim backing material to form a nonwoven material. The scrim can be replaced by uniaxial filaments in cross or lengthwise direction, or by knit, multiaxial scrim, or some combination thereof The reinforcement material is preferably PTFE, but others can be used like FEP, polyoxymethylene (PFA), ethylene tetrafluoro ethylene (ETFE), copolymer, polyester (PES), polyvinyl alcohol (PVA), glass fiber, carbon fiber or other kind of fibers. A second batt can be formed onto the other side of the scrim and needle punched again. The felt should be needle punched or intermingled by jets of water (hydroentanglement), several times to interlock the split film sufficiently to the scrim. This product may then be heat set while being restrained in the cross machine direction for several minutes to improve the thermal stability. In the preferred embodiment, the final nonwoven preferably has a weight of approximately 50 to 3000 g/m². Also, an expanded PTFE membrane can be laminated in conjunction with the felt by an adhesive. In the preferred embodiment, the felt of the present invention shows 626 g/m² weight, 1.1. mm thickness, 510 lb/inch² burst strength and 26 cfm/ft² air permeability.

### EXAMPLE 1

One embodiment of the felt of the present invention was produced in the following manner: a fine powder PTFE resin was mixed with a liquid lubricant, extrusion aid, in a proportion ranging from 22% of lubricant and 78% of PTFE, respectively. In a following step the material was compressed, forming a billet and extruded in a ram type extruder obtaining an extruded preform.

Subsequently the extruded preform was passed through calender rollers in order to form a tape with a thickness of 100 μm, and then the liquid lubricant was volatilized and removed by passing the tape through an oven at a temperature of 220° C. The dry tape was stretched uniaxially in the longitudinal direction 6 times its original length by passing the dry tape through tension rollers operating with a stretched ratio of 6:1 and temperature of 350° C. A thin film of 33 μm thick and 2.0 g/cm³ of density was formed. In the next step the film was split by a needle blade roll producing a net. The net was further stretched in the cross direction increasing the original width by passing over curve bars and then was laid down over a conveyor belt by a crosslapper, forming a batt of net-like structure over a PTFE woven scrim. This material was processed by needle punching to give a felt of 390 g/m² weight, which was wound up on a roll. The felt was then turned over and passed again through the needling machine. Another batt of net-like structure was laid down over the back side of the felt and intermingled again by needle punching. The final needle punched felt showed an air permeability of 45 cfm/ft² and weight of 620 g/m².

A fluorocarbon-based surfactant was coated onto the felt and was heat cured in an over. Then the material was densified by passing through a pair of smooth calendar rols heat at 220° C. The gap between the rolls was adjusted to provide a final thickness of 1 mm. The finished laminate had a weight of 626 g/m², 1.1 mm thickness, 26 cfm/ft², air permeability and 510 lb/inch² of burst strength.

### EXAMPLE 2

One embodiment of the felt of the present invention was produced in a similar matter as in Example 1 but with different tape. The tape used in Example 2 had a 1.1 g/cm³ density. The same extrudate as in Example 1 was passed through calendar rollers in order to form a tape with a thickness of 1000 μm, and then the liquid lubricant was volatilized and removed by passing the tape through an oven at a temperature of 220° C. The dry tape was stretched uniaxially in the longitudinal direction 150 times its original length, forming a thin film with 32 μm thickness and 1.1 g/cm³ density. In the next step the film was split by a needle blade roll forming a net. The net was further stretched in cross direction 10 times the original width by passing over curved bars and then laid down over a conveyor belt by a crosslapper, forming a batt of net-like structure over a PTFE woven scrim. This material was processed by needle punching, giving a felt of 385 g/m² weight, which was wound up on a roll. The felt was then turned over and passed again through the needling machine. Another batt of net-like structure was laid down over the back side of the felt and intermingled again by needle punching. The final needle punched felt showed an air permeability of 40 cfm/ft² and weight of 635 g/m².

A fluorocarbon-based surfactant was coated onto the felt and was heat cured in a oven. Then the material was densified by passing through a pair of smooth calender rolls heated at 220° C. The gap between the rolls was adjusted to provide a final thickness of 1.0 mm. The finished laminate had a weight of 639 g/m², air permeability of 21 cfm/ft² and burst strength of 580 lb/inch².

Other and further embodiments utilizing one or more aspects of the inventions described above can be devised without departing from the spirit of Applicant's invention. Further, the various methods and embodiments of the invention can be included in combination with each other to produce variations of the disclosed methods and embodiments. Discussion of singular elements can include plural elements and vice-versa.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range of equivalent of the following claims.

What is claimed is:

1. A nonwoven material comprising:
a web of fluoropolymer film material from uniaxially stretched fibrillated film split in a lengthwise direction to form a network structure;
wherein the material is formed into a batt without cutting, and wherein the material is entangled.

2. The nonwoven material of claim 1 wherein the fibrillated film is mechanically split.

3. The nonwoven material of claim 1 further comprising a woven scrim.

4. The nonwoven material of claim 3 wherein the woven scrim is attached to a felt by a needle punch intermingling of the felt with the scrim.

5. The nonwoven material of claim 4 where a second batt is attached on to the other side of the scrim and needle-punched again.

6. The nonwoven material of claim 3 further comprising filaments in a transversal direction relative to the nonwoven material.

7. The nonwoven material of claim 3 further comprising filaments in a lengthwise direction relative to the nonwoven material.

8. The nonwoven material of claim 3 further comprising a knitted material.

9. The nonwoven material of claim 3 further comprising a multiaxial woven material.

10. The nonwoven material of claim 3 further comprising filaments in transversal direction relative to the nonwoven material and filaments in a lengthwise direction to the nonwoven material.

11. The nonwoven material of claim 1 wherein the fibrillated film is laid down in a transversal direction relative to the nonwoven material.

12. The nonwoven material of claim 1 wherein the fibrillated film is laid down in a lengthwise direction relative to the nonwoven material.

13. The nonwoven material of claim 1 wherein the fibrillated film comprises polytetrafluoroethylene, fluorinated ethylene propylene, polyoxymethylene, ethylene tetrafluoro ethylene or another fluoropolymer.

14. The nonwoven material of claim 3 wherein the reinforcement comprises polytetrafluoroethylene, fluorinated ethylene propylene, polyoxymethylene, polyester, polyvinyl alcohol, glass fiber, or carbon fiber.

15. The nonwoven material of claim 1 wherein the split film layers are joined by a needle punch intermingling.

16. The nonwoven material of claim 1 wherein the split film layers are joined by hydroentanglement.

17. The nonwoven material of claim 1 wherein a polytetrafluoroethylene membrane is attached to the felt by an adhesive.

18. The nonwoven material of claim 17 wherein the adhesive is a fluorinated polymer.

19. The nonwoven material of claim 1 wherein the nonwoven material is in the form of a filter bag.

20. A method for producing a nonwoven material from film split into microfibers comprising the steps of:
(a) forming a film;
(b) splitting the film to form a network of fibers;
(c) forming a batt from the film without cutting it into network of fibers; and
(d) entangling the batt.

21. The method of claim 20, wherein step (a) comprises the steps of:
(1) mixing a polytetrafluoroethylene resin and liquid lubricant to form a compound;
(2) pressing the compound to form a billet;
(3) forcing the billet to a die to form an extrudate;
(4) pressing the extrudate to form a tape;
(5) drying the tape to remove the liquid lubricant;
(6) stretching the tape to form a film; and
(7) winding the film;

22. The method of claim 20, wherein step (d) comprises the steps of:
(1) stretching the film in a cross direction in relation to the split to form a net-like film;
(2) combining several layers of the net-like film to form a batt;
(3) needle punching the batt into a scrim backing material;
(4) combining several layers of the net-like film to form a second batt;
(5) needle punching the second batt again on to the other side of the scrim backing material; and
(6) interlocking the split film and the scrim backing material.
